(19) United States
(12) Patent Application Publication
(10) Pub. No.: US 2014/0069418 A1
(43) Pub. Date: Mar. 13, 2014

(54) COLLAPSIBLE CAMP STOVE

(71) Applicant: Merkwares, LLC, Eagle Mountain, UT (US)

(72) Inventor: Mikhail E. Merkurieff, Eagle Mountain, UT (US)

(73) Assignee: Merkwares, LLC, Eagle Mountain, UT (US)

(21) Appl. No.: 14/081,891

(22) Filed: Nov. 15, 2013

Related U.S. Application Data
(63) Continuation-in-part of application No. 29/451,615, filed on Apr. 4, 2013, now Pat. No. D693623.
Application No. 29/451,615 is a continuation of application No. 29/404,287, filed on Oct. 18, 2011, now Pat. No. D682006.

(51) Int. Cl. A47J 33/00

(52) U.S. Cl. CPC A47J 33/00
USPC 126/9 R

(57) ABSTRACT

Example embodiments of the present invention provide a collapsible camp stove that is easy to pack and use when participating in outdoor recreational activities, such as hiking and camping. Example embodiments of the collapsible camp stove provide a stove that can collapse to provide a small packing volume that is lightweight. When assembled, the collapsible camp stove provides a structure to easily use fuels naturally occurring in the outdoors (e.g., wood) to start a fire for a heat source. The structure further provides a stand to support a cooking container over the heat source so a user can use the collapsible camp stove to heat the contents of the cooking container. Also, because the collapsible camp stove is designed to use fuels that are naturally found in the outdoors, the user does not have to worry about running out of fuel.

### CROSS-REFERENCE TO RELATED APPLICATIONS

This application claims priority to and is a continuation-in-part of U.S. patent application Ser. No. 29/451,615, filed on Apr. 4, 2013, and titled “Collapsible Camp Stove,” which is a continuation of U.S. patent application Ser. No. 29/404,287, filed on Oct. 18, 2011, and titled “Collapsible Camp Stove,” and now issued as U.S. Pat. No. D682,006, the entire contents of each patent and application is hereby incorporated herein by reference.

### TECHNICAL FIELD OF THE INVENTION

The present disclosure generally relates to outdoor cookware, and in particular to a collapsible camp stove.

### BACKGROUND OF THE INVENTION

When participating in outdoor recreational activities, like backpacking, hiking, or camping, it is often desirable for a user to carry transportable cooking equipment, including camping or backpacking stoves. Most conventional camping or backpacking stoves include a burner portion and a pressurized fuel tank portion. Depending on the design of the stove, the user usually connects the fuel tank portion to the burner portion to provide the fuel to the burner. The user can ignite the fuel as it exits the burner to create a heat source for cooking The burner portion may include a stand or similar fixture that allows the user to support a cooking container above the burner, which allows the user to heat the contents of the cooking container.

Conventional camping and backpacking stoves, as described above, have several disadvantages. For example, conventional camping and backpacking stoves require a fuel tank. The fuel tanks take up valuable space in a user's backpack. Not only does the fuel tank take up space, but the fuel tank also adds weight to the user's backpack creating a heavier backpack. In addition, if the fuel tank runs out of fuel on the trip, the conventional backpacking stove will not function.

Furthermore, conventional backpacking stoves have various working parts that can become damaged during packing or use. For example, a conventional gas backpacking stove, as described above, may include one or more gas valves, fuel lines, couplers or connections. If any one of these parts are damaged or broken, the backpacking stove may not function, or may become unsafe to use.

Accordingly, there is a need for an improved camping or backpacking stoves.

### SUMMARY OF THE INVENTION

Example embodiments of the present invention provide a collapsible camp stove that is easy to pack and use when participating in outdoor recreational activities, such as hiking and camping. Example embodiments of the collapsible camp stove provide a stove that can collapse to provide a small packing volume that is lightweight. When assembled, the collapsible camp stove provides a structure to easily use fuels naturally occurring in the outdoors (e.g., wood) to start a fire for a heat source. The structure further provides a stand to support a cooking container over the heat source so a user can use the collapsible camp stove to heat the contents of the cooking container. Also, because the collapsible camp stove is designed to use fuels that are naturally found in the outdoors, the user does not have to worry about running out of fuel.

In one example embodiment, the collapsible camp stove includes a first panel, a second panel coupled to the first panel, a third panel coupled to the second panel, and a fourth panel coupled to the third panel and the first panel. The first panel, the second panel, the third panel and the fourth panel are coupled together to form a four-sided structure with a top opening and a bottom opening. The collapsible camp stove further includes a bottom panel that interfaces with the second panel, the third panel, and the fourth panel. The bottom panel can be positioned proximate the bottom opening of the four-sided structure. In addition, the collapsible camp stove can include a plurality of air inlets within the first panel located at a vertical position on the first panel such that the air inlets are positioned proximate to the bottom panel.

In another example embodiment, the collapsible camp stove includes a four-sided structure having a top opening and a bottom opening, the four-sided structure including a first panel, a second panel, a third panel and a fourth panel. Additionally, the collapsible camp stove includes a bottom panel having a solid surface configuration, with the bottom panel positioned within the four-sided structure proximate to the bottom opening. The collapsible camp stove can further include an air inlet formed within each of the first panel, the second panel, the third panel and the fourth panel and be positioned in their respective panels such that each air inlet is vertically positioned between the bottom panel and the top opening and proximate to the bottom panel.

Additionally, in another example embodiment, the collapsible camp stove can include a four-sided structure having a top opening and a bottom opening. The four-sided structure includes a first panel, a second panel, a third panel and a fourth panel. In addition, the collapsible camp stove includes a first interface element formed within at least one of the first panel, the second panel, and the third panel. Moreover, a bottom panel having a solid surface configuration can be positioned within the four-sided structure proximate to the bottom opening. The bottom panel can include a second interface element located on at least one edge of the bottom panel. The second interface element interfaces with the first interface element to secure the bottom panel to the four-sided structure. The collapsible camp stove can further include an air inlet formed within each of the first panel, the second panel, the third panel and the fourth panel. The air inlet in each of the first panel, the second panel, the third panel, and the fourth panel is vertically positioned between the bottom panel and the top opening and is positioned proximate to the bottom panel.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical implementations of the invention and are not therefore to be considered to be limiting of its scope, the invention will be described and explained with additional specificity and detail through the use of the accompanying drawings.

FIG. 1 illustrates a perspective view of a collapsible camp stove;

FIG. 2 illustrates a front elevational view of the collapsible camp stove;

FIG. 3 illustrates a rear elevational view of the collapsible camp stove;

FIG. 4 illustrates a right side elevational view of the collapsible camp stove;

FIG. 5 illustrates a left side elevational view of the collapsible camp stove;

FIG. 6 illustrates a top plan view of the collapsible camp stove; and

FIG. 7 illustrates a bottom plan view of the collapsible camp stove.

### DETAILED DESCRIPTION OF THE INVENTION

Example embodiments of the present invention provide a collapsible camp stove that is easy to pack and use when participating in outdoor recreational activities, such as hiking and camping. Example embodiments of the collapsible camp stove provide a stove that can collapse to provide a small packing volume that is lightweight. When assembled, the collapsible camp stove provides a structure to easily use fuels naturally occurring in the outdoors (e.g., wood) to start a fire for a heat source. The structure further provides a stand to support a cooking container over the heat source so a user can use the collapsible camp stove to heat the contents of the cooking container.

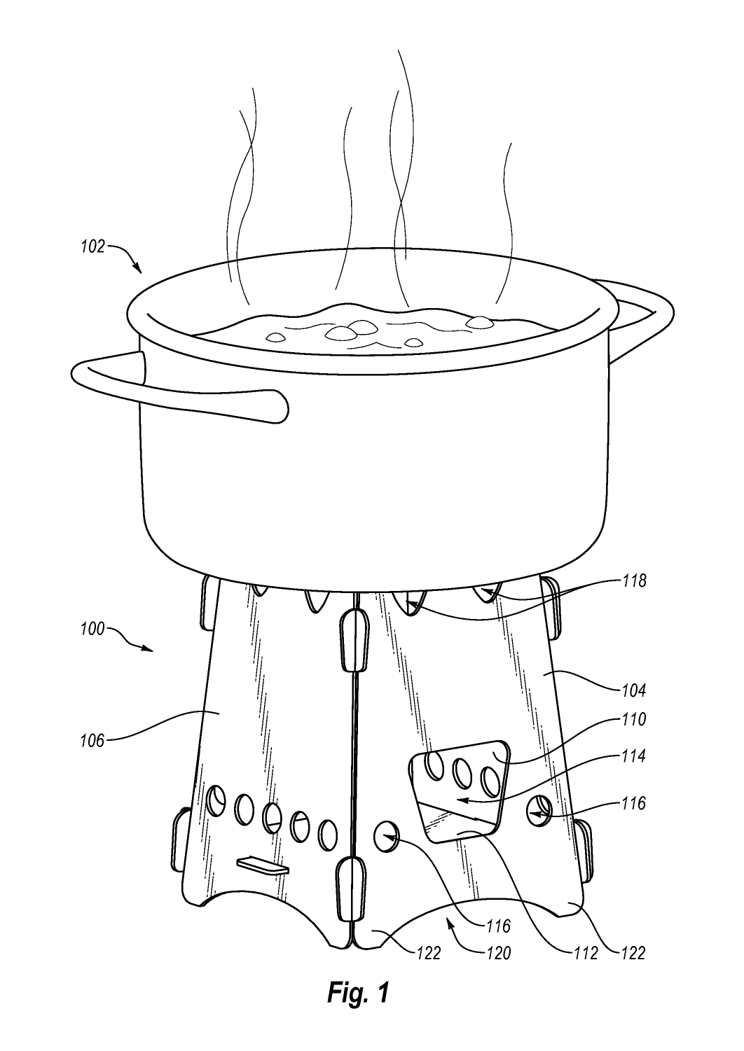

The above and additional advantages of the present invention will be discussed further with respect to the Figures. For example, FIG. 1 illustrates a perspective view of a collapsible camp stove 100. As shown in FIG. 1, the collapsible camp stove 100 is configured to support a cooking container 102. For example, and as illustrated, the user can position the cooking container 102 on the collapsible camp stove 100 such that cooking container is directly over the heat source located substantially under the cooking container 102.

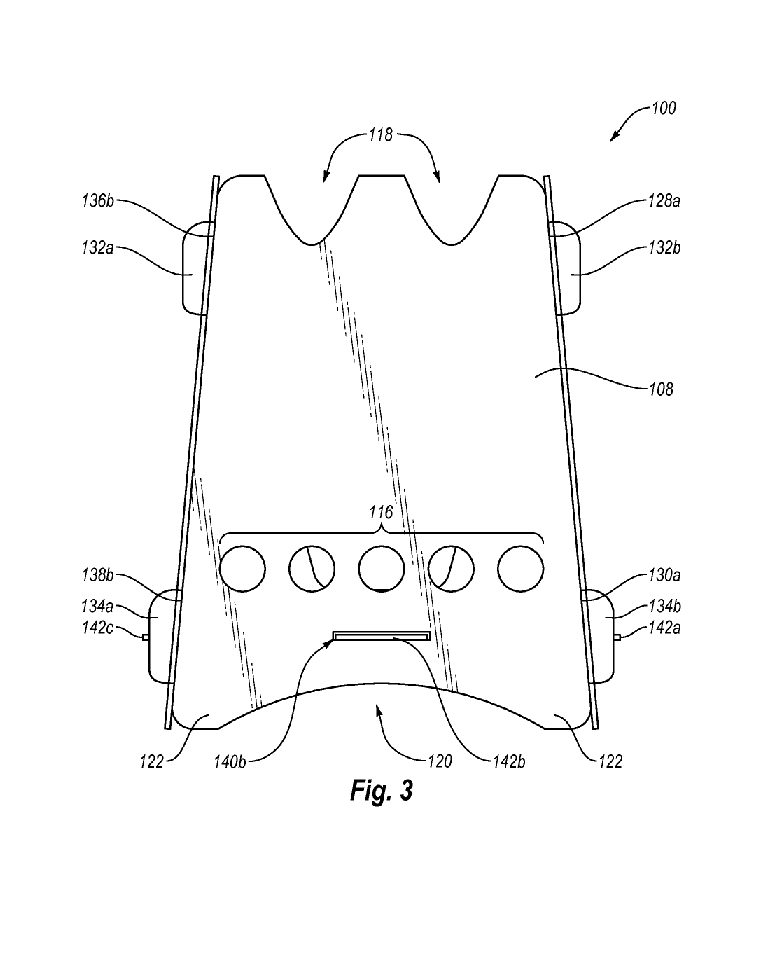

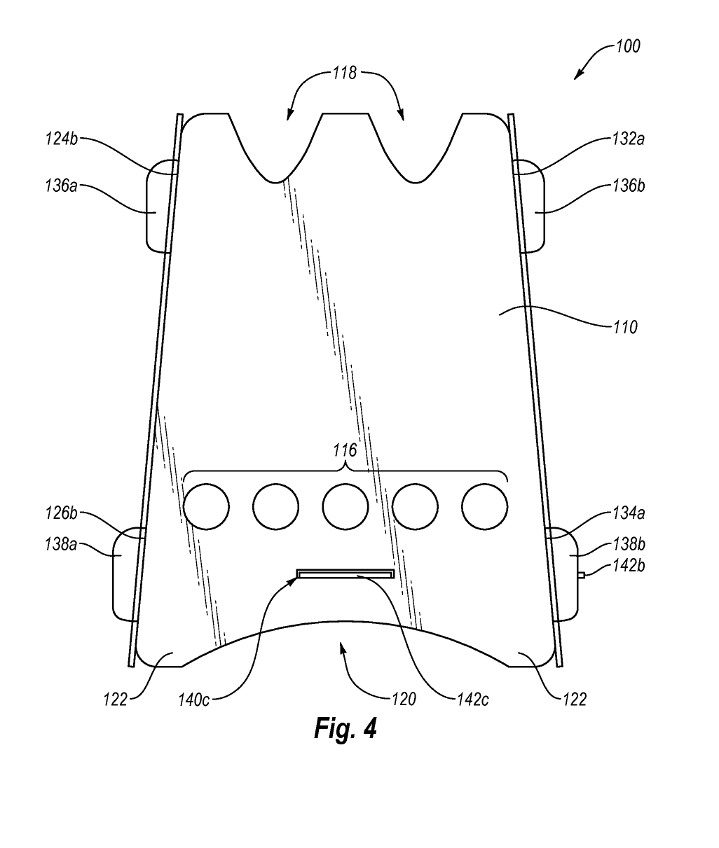

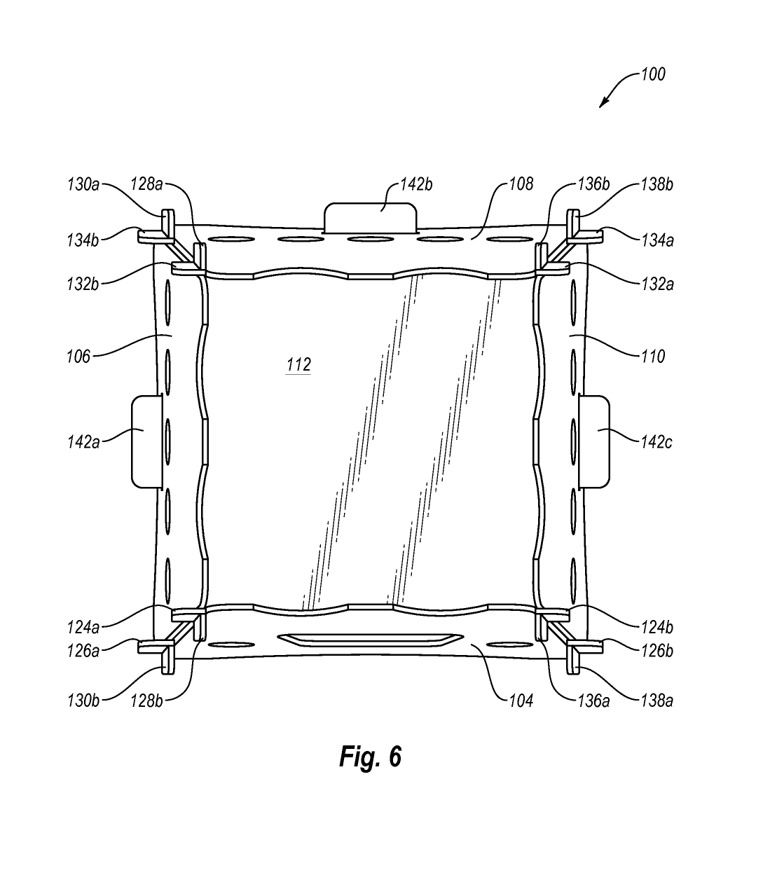

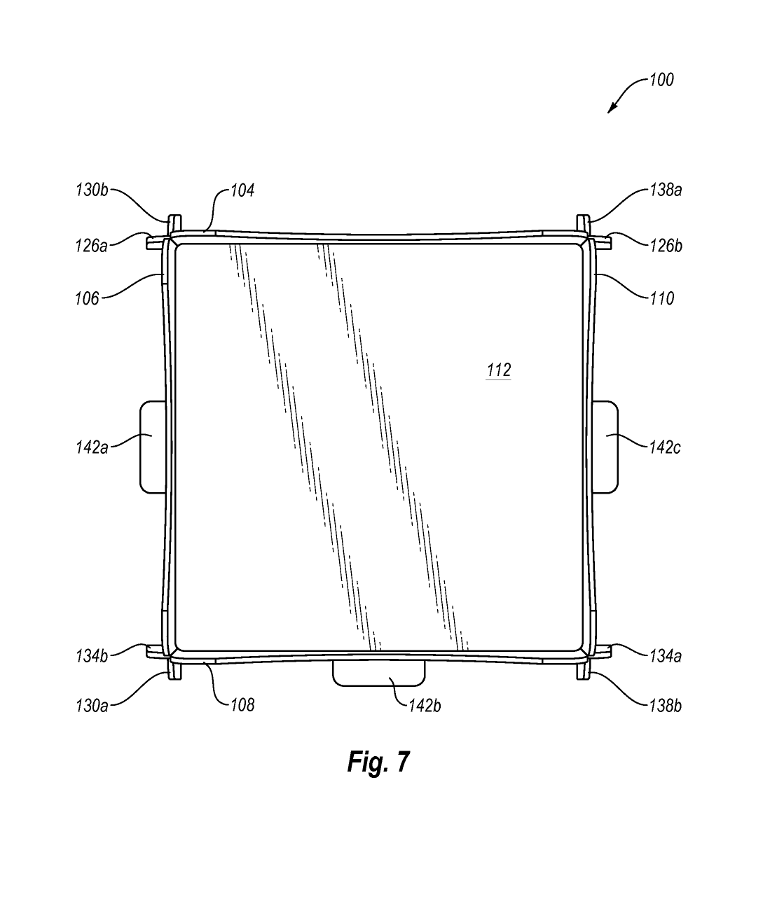

As further illustrated in FIG. 1, the collapsible camp stove 100 can include a first panel 104, a second panel 106, a third panel 108 (see FIGS. 3 and 6), and a fourth panel 110 (see also FIGS. 4 and 6). The collapsible camp stove 100 further can include a bottom panel 112 (see also FIGS. 6 and 7). When all the panels are coupled together, a combustion chamber is formed that is substantially surrounded by the panels. The user can place the fuel into the combustion chamber and ignite the fuel to create the heat source that is located substantially beneath the cooking container 102.

As illustrated in FIG. 1, a user can assemble or couple the first panel 104, second panel 106, third panel 108, fourth panel 110, and bottom panel 112 to form the assembled collapsible camp stove 100 shown in FIG. 1. After use, the user can then disassemble or separate the collapsible camp stove 100 so that each panel is no longer coupled to any other panel. Therefore, in the disassembled or separated state, the first panel 104, second panel 106, third panel 108, fourth panel 110, and bottom panel 112 can be laid flat against each other to easily be stored and packed, for example, in the user's backpack.

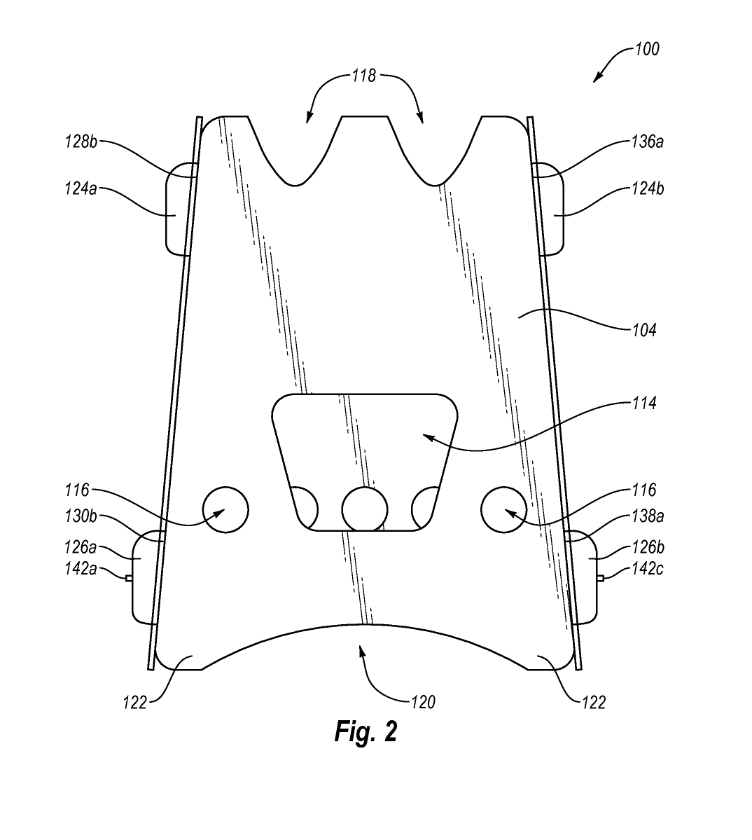

In one example embodiment, as shown in FIGS. 1 and 2, the first panel 100 can include a window 114. The window 114 can be sized to allow the user to add fuel through the window 114, whether either to load the combustion chamber or to reload the combustion camber during use. As illustrated in FIGS. 1 and 2, the window 114 has a trapezoidal geometric configuration, with the bottom edge of the window 114 located above the bottom panel 112, which can secure the fuel and/or ash within the combustion chamber during use while providing an opening to add additional fuel.

In addition to the window 114, the first panel can include air inlets 116. As shown in FIGS. 1 and 2, the air inlets 116 are positioned on each side of the window 114. Additionally, the air inlets 116 are positioned proximate to, but above, the bottom panel 112. This positioning of the air inlets 116 allows air to enter the combustion chamber through the air inlets 116 during use so that the fuel can efficiently burn within the combustion chamber to create the heat source.

Similar to how the air inlets 116 allow air to enter the combustion chamber, the first panel 104 can also include upper cutouts 118 that allow the exhaust air to exit the combustion chamber. As shown in FIGS. 1 and 2, the upper cutouts 118 can have a substantially U-shaped or V-shaped geometric configuration. As further illustrated in FIGS. 1 and 2, the upper cutouts 118 can be positioned equidistant from each corresponding edge of the first panel 104 such that the upper cutouts 118 are symmetrically positioned on the upper edge of the first panel 104.

The lower portion of the first panel 104 can include a lower cutout 120, as illustrated in FIGS. 1 and 2. As shown, the lower cutout 120 can have a rounded arch configuration that is positioned substantially in the center of the bottom edge of the first panel 104. Due to the geometric configuration and position of the lower cutout 120, the first panel 104 further includes feet 122. The feet 122 have a substantially flat edge, as illustrated in FIGS. 1 and 2, with the flat edge designed to rest on the ground during use of the collapsible camp stove 100.

In addition to the above features, the first panel 104 can further include upper first panel hooks 124a and 124b and lower first panel hooks 126a and 126b, as illustrated in FIG. 2. The upper first panel hooks 124a and 124b and the lower first panel hooks 126a and 126b are configured to interface with similar hooks on the second panel 106 and the fourth panel 110 to couple the first panel 104 to the second panel 106 and to couple the first panel 104 to the fourth panel 110 as illustrated in FIGS. 1, 6 and 7. In particular, each of the first panel 104, second panel 106, third panel 108 and fourth panel 110 include upper hooks and lower hooks to couple adjacent panels together as illustrated in FIGS. 1, 6 and 7.

In general, the upper hooks and lower hooks are configured with either an upward facing hook or a downward facing hook. The upward facing hooks are configured so that the opening of the hook is toward the top of the panel. The downward facing hooks are configured so that the opening of the hook is toward the bottom of the panel. The upward facing hooks are configured to interface with the downward facing hooks to form the interface between each panel. For example, the upper hook 124a and lower hook 126a on the first panel 104 can be upward facing hooks and interface with upper hook 128b and lower hook 130b on the second panel 106, which can be downward facing hooks.

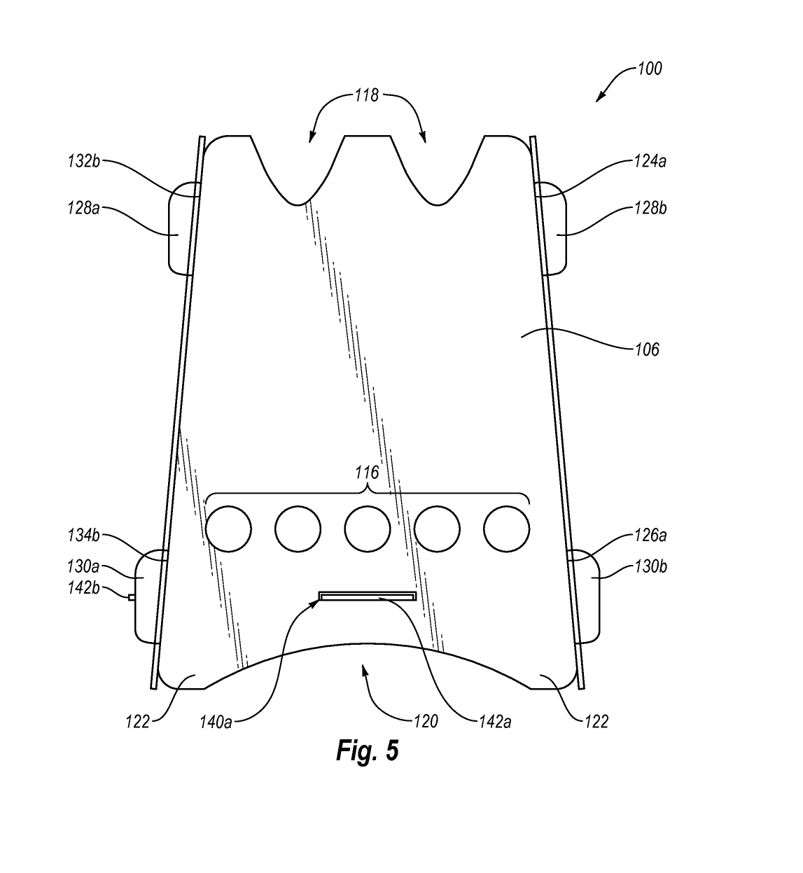

In more particularity, FIGS. 2 through 7 illustrate how the respective upper hooks and lower hooks from each panel interface to assemble the collapsible camp stove 100. FIG. 6 will be referenced for purposes of explanation of the interface of the upper hooks and lower hooks of each panel. For example, FIG. 6 illustrates that the first panel 104 is coupled to the second panel 106. In particular, the upper first panel hook 124a couples with upper second panel hook 128b and lower first panel hook 126a couples with lower second panel hook 130b.

Continuing with reference to FIG. 6, the second panel 106 is coupled to the third panel 108 as shown in FIG. 6. In particular, the upper second panel hook 128a couples with the upper third panel hook 132b and the lower second panel hook 130a couples with the lower third panel hook 134b.

Similar to above, the third panel 108 is coupled to the fourth panel 110 as shown in FIG. 6. In particular, the upper third panel hook 132a couples with the upper fourth panel hook 136b and the lower third panel hook 134a couples with the lower forth panel hook 138b.

As with the previous panels, the fourth panel 110 is coupled to the first panel 104 as shown in FIG. 6. In particular, the upper fourth panel hook 136a couples with the upper first panel hook 124b and the lower fourth panel hook 138a couples with the lower first panel hook 126b.

To complete the collapsible camp stove 100 assembly, the bottom panel 112 couples to the second panel 106, third panel 108, and fourth panel 110. In particular, each of the second panel 106, third panel 108, and fourth panel 110 include a slot 140a, 140b, and 140c, respectively as illustrated in FIGS. 3 through 5. The bottom panel 112 includes tabs 142a, 142b, and 142c as illustrated in FIGS. 6 and 7. Each of the tabs 142a, 142b, and 142c can be inserted in to slots 140a, 140b, and 140c, and thereby, the bottom panel 112 is coupled to, and supported by, the second panel 106, third panel 108, and fourth panel 110.

In particular, each of the tabs 142a, 142b and 142c interface with each of the slots 140a, 140b and 140c, respectively. As illustrated in FIGS. 1 through 7, interfacing means that the tab of the bottom panel 112 actually is inserted through the slots in the panels so that the tabs are visually seen on the outside of the collapsible camp stove 100, as illustrated in FIGS. 1 through 7.

In addition to the various elements of the panels that enable the assembly of the collapsible camp stove 100, each of the panels have various other elements. For example, FIGS. 3 through 5 illustrate a front view of the second panel 106, the third panel 108 and the fourth panel 110. As illustrated, the second panel 106, the third panel 108 and the fourth panel 110 can include air inlets 116. The air inlets can have all the same features and properties as the air inlets discussed above with reference to the first panel 104. Different from the first panel 104, however, FIGS. 3 through 5 show that the second panel 106, the third panel 108 and the fourth panel 110 can include five air inlets 116 in a substantially horizontal row configuration.

In addition, and similar to the first panel 104, the second panel 106, the third panel 108 and the fourth panel 110 can include upper cutouts 118 as illustrated in FIGS. 3 through 5. The upper cutouts 118 of the second panel 106, the third panel 108 and the fourth panel 110 can have the same features and properties as discussed above with reference to the upper cutouts 118 of the first panel 104.

Moreover, the second panel 106, the third panel 108 and the fourth panel 110 can include a lower cutout 120. As illustrated in FIGS. 3 through 5, the lower cutout can form feet 122 that are designed to interface with the ground when the collapsible stove 100 is in use. The lower cutout 120 and the feet 122 of the second panel 106, the third panel 108 and the fourth panel 110 can have the same features and properties as discussed above with respect to the lower cutout 120 and the feet 122 on the first panel 104.

Different from the first panel 104, and as discussed above with reference to the assembly of the collapsible camp stove, each of the second panel 106, the third panel 108 and the fourth panel 110 can include a slot 140a, 140b, and 140c, respectively. As illustrated in FIGS. 3 through 5, the slots 140a, 140b, and 140c can be substantially centered horizontally within each of the second panel 106, the third panel 108 and the fourth panel 110. In addition, the slots 140a, 140b, and 140c can be vertically positioned substantially toward the bottom of the second panel 106, the third panel 108 and the fourth panel 110, as illustrated in FIGS. 3 through 5.

As discussed above, the slots 140a, 140b, and 140c are sized and geometrically configured (e.g., with a rectangular configuration) to interface with the tabs 142a, 142b, and 142c of the bottom panel 112. As illustrated in FIGS. 6 and 7, the bottom panel 112 is a solid panel, or has a solid surface configuration. For example, a solid surface configuration means the bottom panel 112 does not include any holes, vents, or other cutout features. Instead, the bottom panel 112 is a substantially flat solid piece of material with tabs 142a, 142b and 142c configured to interface with the slots 140a, 140b, and 140c in the second panel 106, the third panel 108 and the fourth panel 110.

Each of the first panel 104, the second panel 106, the third panel 108 and the fourth panel 110 can have a substantially trapezoidal geographic configuration, meaning that the two side edges of each of the first panel 104, and second panel 106, the third panel 108 and the fourth panel 110 are not parallel. Due to the trapezoidal geometric configuration of the first panel 104, the second panel 106, the third panel 108 and the fourth panel 110, the base of the collapsible stove 100, when assembled, has a larger perimeter compared to the perimeter of the top of the collapsible stove 100, as illustrated in FIGS. 1 and 6.

Therefore, when assembled, each of the first panel 104, the second panel 106, the third panel 108, and the fourth panel 110 form a four-sided structure, as illustrated in FIGS. 1, 6 and 7 that has a top opening and a bottom opening, with the bottom opening having a larger perimeter than the perimeter of the top opening. As illustrated in FIG. 7, the bottom panel 112 can have a perimeter slightly smaller than the perimeter of the bottom opening so that when assembled, the bottom panel is positioned proximate to the bottom opening of the four-sided structure.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A collapsible camp stove, comprising:
a first panel;
a second panel coupled to the first panel;
a third panel coupled to the second panel;
a fourth panel coupled to the third panel and the first panel, wherein the first panel, the second panel, the third panel and the fourth panel are coupled together to form a four-sided structure with a top opening and a bottom opening;
a bottom panel interfacing with the second panel, the third panel, and the fourth panel, wherein the bottom panel is positioned proximate the bottom opening of the four-sided structure; and
a plurality of air inlets within the first panel located at a vertical position on the first panel such that the plurality of air inlets is positioned proximate to the bottom panel.

2. The collapsible camp stove of claim 1, wherein the bottom panel has a solid surface configuration.

3. The collapsible camp stove of claim 1, further comprising a slot in each of the second panel, the third panel, and the fourth panel, wherein each of the slots is located proximate the bottom opening of the four-sided structure.

4. The collapsible camp stove of claim 3, further comprising a plurality of tabs on the bottom panel, each tab located on an outside perimeter of the bottom panel, and each tab configured to interface with one of the slots located in the second panel, the third panel and the fourth panel.

5. The collapsible camp stove of claim 4, wherein the bottom panel is supported by the second panel, the third panel, and the fourth panel by way of each of the tabs interfacing with each of the slots, respectively.

6. The collapsible camp stove of claim 1, further comprising a window formed within the first panel.

7. The collapsible camp stove of claim 6, wherein the window is positioned on the first panel at a vertical position between the bottom panel and the top opening, and is further positioned proximate the bottom panel.

8. The collapsible camp stove of claim 1, further comprising a pair of upper hooks located on an upper portion of each of the first panel, the second panel, the third panel and the fourth panel.

9. The collapsible stove of claim 8, further comprising a pair of lower hooks located on a lower portion of each of the first panel, the second panel, the third panel, and the fourth panel.

10. A collapsible camp stove, comprising:
a four-sided structure having a top opening and a bottom opening, the four-sided structure comprising a first panel, a second panel, a third panel and a fourth panel;
a bottom panel having a solid surface configuration and positioned within the four-sided structure proximate to the bottom opening; and
an air inlet formed within each of the first panel, the second panel, the third panel and the fourth panel,
wherein the air inlet in each of the first panel, the second panel, the third panel and the fourth panel is vertically positioned between the bottom panel and the top opening, and further positioned proximate to the bottom panel.

11. The collapsible camp stove of claim 10, further comprising a window located in the first panel and vertically positioned between the bottom panel and the top opening.

12. The collapsible camp stove of claim 11, further comprising a lower cutout located on a bottom edge of each of the first panel, the second panel, the third panel and the fourth panel.

13. The collapsible camp stove of claim 12, further comprising feet located on the bottom edge of each of the first panel, the second panel, the third panel and the fourth panel, wherein the bottom cutout at least partially forms the feet.

14. The collapsible camp stove of claim 13, wherein at least one of the second panel, the third panel and the fourth panel further comprises additional air inlets in a horizontal row configuration with the air inlet.

15. The collapsible camp stove of claim 13, wherein each of the second panel, the third panel, and the fourth panel further comprises additional air inlets in a horizontal row configuration with the air inlet in each of the second panel, the third panel and the fourth panel.

16. A collapsible camp stove, comprising:
a four-sided structure having a top opening and a bottom opening, the four-sided structure comprising a first panel, a second panel, a third panel and a fourth panel;
a first interface element formed within at least one of the first panel, the second panel, and the third panel;
a bottom panel having a solid surface configuration and positioned within the four-sided structure proximate to the bottom opening;
a second interface element located on at least one edge of the bottom panel, wherein the second interface element interfaces with the first interface element; and
an air inlet formed within each of the first panel, the second panel, the third panel and the fourth panel, wherein the air inlet in each of the first panel, the second panel, the third panel, and the fourth panel is vertically positioned between the bottom panel and the top opening and is further positioned proximate to the bottom panel.

17. The collapsible stove of claim 16, further comprising a pair of upper hooks located on an upper portion of each of the first panel, the second panel, the third panel and the fourth panel.

18. The collapsible stove of claim 17, further comprising a pair of lower hooks located on a lower portion of each of the first panel, the second panel, the third panel and the fourth panel.

19. The collapsible stove of claim 18, wherein one half of the total number of upper hooks comprise an upward facing hook.

20. The collapsible stove of claim 19, wherein one half of the total number of lower hooks comprise a downward facing hook.
